(19) United States
(12) Patent Application Publication
(10) Pub. No.: US 2014/0222666 A1
(43) Pub. Date: Aug. 7, 2014

(54) METHOD AND APPARATUS FOR PROCESSING ELECTRONIC TRANSACTION INFORMATION

(71) Applicants: Hao Feng, Guangdong (CN); Kaipeng Xu, Guangdong (CN); Wubo Cao, Guangdong (CN); Tao Hu, Guangdong (CN)

(72) Inventors: Hao Feng, Guangdong (CN); Kaipeng Xu, Guangdong (CN); Wubo Cao, Guangdong (CN); Tao Hu, Guangdong (CN)

(73) Assignee: TENCENT TECHNOLOGY (SHENZHEN) COMPANY LIMITED, Guangdong (CN)

(21) Appl. No.: 14/248,997

(22) Filed: Apr. 9, 2014

Related U.S. Application Data
(63) Continuation of application No. PCT/CN2013/085021, filed on Oct. 11, 2013.

(30) Foreign Application Priority Data
Oct. 15, 2012 (CN) 201210389695.8

(51) Int. Cl. G06Q 20/12

(52) U.S. Cl. CPC G06Q 20/12
USPC 705/39

(57) ABSTRACT

The present invention relates to a method and apparatus for processing electronic transaction information, the method comprising: accepting a payment request submitted by a channel entrance page, the payment request comprising an electronic tag corresponding to the channel entrance page; making a payment in accordance with the payment request and outputting a payment result; identifying a distribution platform corresponding to the electronic tag; generating a payment result page based on the identified distribution platform; and outputting the payment result page. In accordance with the method and apparatus for processing electronic transaction information of the present invention, electronic tags are embedded in the processing steps of the electronic transactions, and two or more independent and closed transaction processing systems sharing the same payment process can be established. Thus, the amount of work and cost for establishing electronic transaction distribution platforms can be reduced.

### CROSS-REFERENCE TO RELATED APPLICATIONS

This application is a continuation of International Patent Application No. PCT/CN2013/085021, entitled “Method and Apparatus for Identifying Initiation Items,” filed on Oct. 11, 2013. This application claims the benefit and priority of Chinese Patent Application No. 201210389695.8, entitled “Method and Apparatus for Processing Electronic Transaction Information,” filed on Oct. 15, 2012. The entire disclosures of each of the above applications are incorporated herein by reference.

### TECHNICAL FIELD

The present invention relates to the establishment of online distribution platforms, and more particularly, to a method and apparatus for processing electronic transaction information that can be used to quickly establish online distribution platforms.

### BACKGROUND

With the growing popularity of the Internet, e-commerce is becoming more and more accepted. Due to its convenience and competitive pricing, online shopping has gradually become an important way for consumers to purchase products and services.

The current electronic transaction platforms generally have a complete and closed transaction process. In other words, the transaction processes of different electronic transaction platforms are mutually independent. In order to establish a new electronic transaction platform or distribution platform, a new closed transaction process needs to be built. However, the transaction processes of different electronic transaction platforms share many things in common. For example, the payment process in different transaction processes is often the same. Due to their closed nature, the existing electronic transaction systems cannot perform different after-payment processing in accordance with different electronic transaction platforms.

### SUMMARY OF THE INVENTION

Thus, it is desirable to provide a method and apparatus for processing electronic transaction information that can be used to quickly establish online distribution platforms.

In accordance with embodiments of the present invention, a method for processing electronic transaction information is provided, the method comprising: accepting a payment request submitted by a channel entrance page, the payment request comprising an electronic tag corresponding to the channel entrance page; making a payment in accordance with the payment request and outputting a payment result; identifying a distribution platform corresponding to the electronic tag; generating a payment result page based on the identified distribution platform; and outputting the payment result page.

In accordance with embodiments of the present invention, an apparatus for processing electronic transaction information is provided, the apparatus comprising: a first receiving unit for accepting a payment request submitted by a channel entrance page, the payment request comprising an electronic tag corresponding to the channel entrance page; a payment unit for making a payment in accordance with the payment request and outputting a payment result; an identification unit for identifying a distribution platform corresponding to the electronic tag; a payment result page generating unit for generating a payment result page based on the identified distribution platform; and a first output unit for outputting the payment result page.

In accordance with the method and apparatus for processing electronic transaction information of the present invention, electronic tags are embedded in the processing steps of the electronic transactions, and two or more independent and closed transaction processing systems sharing the same payment process can be established. Thus, the amount of work and cost for establishing electronic transaction distribution platforms can be reduced.

### BRIEF DESCRIPTION OF THE DRAWINGS

To better illustrate the technical features of the embodiments of the present invention, various embodiments of the present invention will be briefly described in conjunction with the accompanying drawings.

FIG. 1 is an exemplary flowchart for a method for processing electronic transaction information in accordance with an embodiment of the present invention.

FIG. 2 is an exemplary flowchart for a method for processing electronic transaction information in accordance with another embodiment of the present invention.

FIG. 3 is an exemplary schematic diagram for an apparatus for processing electronic transaction information in accordance with yet another embodiment of the present invention.

### DESCRIPTION OF THE PREFERRED EMBODIMENTS

To better illustrate the purpose, technical feature, and advantages of the embodiments of the present invention, various embodiments of the present invention will be further described in conjunction with the accompanying drawings. In the following discussion, the term “client” may refer to, a client terminal device, which includes but is not limited to, a desktop computer, a laptop, a netbook, a tablet, a mobile phone, a multimedia TV and other electronic equipment, or a client side application program.

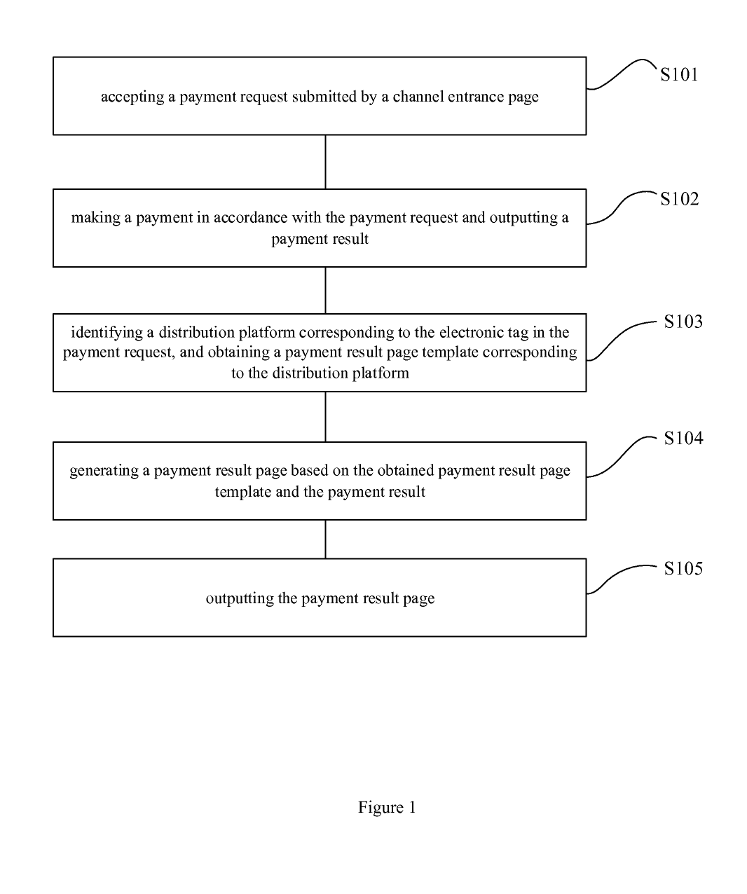

FIG. 1 is an exemplary flowchart for a method for processing electronic transaction information in accordance with an embodiment of the present invention. As shown in FIG. 1, the method includes the following steps:

Step 101: accepting a payment request submitted by a channel entrance page.

The channel above refers to various electronic transaction or distribution platforms. For example, suppose there are a Business-to-Customer (B2C) electronic transaction platform and a Customer-to-Customer (C2C) electronic transaction platform. The B2C electronic transaction platform can provide a variety of prepaid services, such as prepaid phone service, prepaid gaming, and other virtual services. At the same time, vendors can also sell such virtual services on the C2C electronic transaction platform. Thus, the C2C electronic transaction platform becomes a distribution platform for the B2C electronic platform. While these virtual services exist in the two electronic transaction platforms, they actually correspond to the same products.

For the virtual services, the B2C and the C2C electronic transaction platforms represent different channels, and there is a corresponding channel entrance page in each electronic transaction platform. Understandably, the channel entrance page belongs to the electronic transaction platform, and its content and display style must be consistent with the style of the electronic transaction platform. However, in the actual electronic transaction process, user interface data will not be transmitted during the transaction process. Thus, in order to distinguish the channel from which a payment request originates, the channel entrance page needs to include at least one electronic tag. After the user confirms a purchase, the electronic tag will be sent to the server as part of the payment request.

Understandably, the electronic tag discussed above corresponds to a unique channel or distribution platform. In other words, the electronic tag is an identifier or an index for the distribution platform. In actual implementation, the electronic tag can be a number or a string such as “1_{—}1_{—}1_{—}1_{—}1”. The other properties of the electronic tag and its corresponding distribution platform, such as the corresponding payment result page template and order information page template, can also be saved in the electronic tag database. In another words, a step of constructing an electronic tag database can be included before Step 101. In addition, in order to ensure that the result page template and the order information page template work properly, a step of constructing the result page template and the order information page template can be included before Step S101.

Step 102: making a payment in accordance with the payment request and outputting a payment result.

After the server receives the payment request, the payment is made in accordance with the normal payment process. The payment result can include a variety of scenarios, such as payment success or payment failure.

Step 103: identifying a distribution platform corresponding to the electronic tag in the payment request, and obtaining a payment result page template corresponding to the distribution platform.

For example, the distribution platform that the electronic tag belongs to can be determined by searching the electronic tag database; and the payment result page template corresponding to the distribution platform can also be obtained.

Step 104: generating a payment result page based on the obtained payment result page template and the payment result.

For example, the payment result page can be obtained by filling the payment result page template with the payment result. Understandably, the same payment result can be displayed differently in different electronic transaction platforms, such as displaying different logos, or, when there is a payment failure, prompting the user to take appropriate action in the corresponding electronic transaction platform. The payment result page template can be used to implement individualized processing for different distribution platforms.

In addition, the template discussed above is merely provided for illustration purposes only, and this embodiment is not limited to using the template. For example, different distribution platforms may use different logics to generate different payment result pages.

Step 105: outputting the payment result page.

Outputting the payment result page may include, for example, returning the payment result page to a client. The browser on the client can subsequently parse, load, and display the payment result page. The display of the payment result does not necessarily mean the end of the electronic transaction; in order to identify the distribution platform, the payment result page can also include the electronic tag.

In accordance with the method for processing electronic transaction information of this embodiment, electronic tags are embedded in the processing steps of the electronic transactions, and two or more independent and closed transaction processing systems sharing the same payment process can be established. Thus, the amount of work and cost for establishing electronic transaction distribution platforms can be reduced.

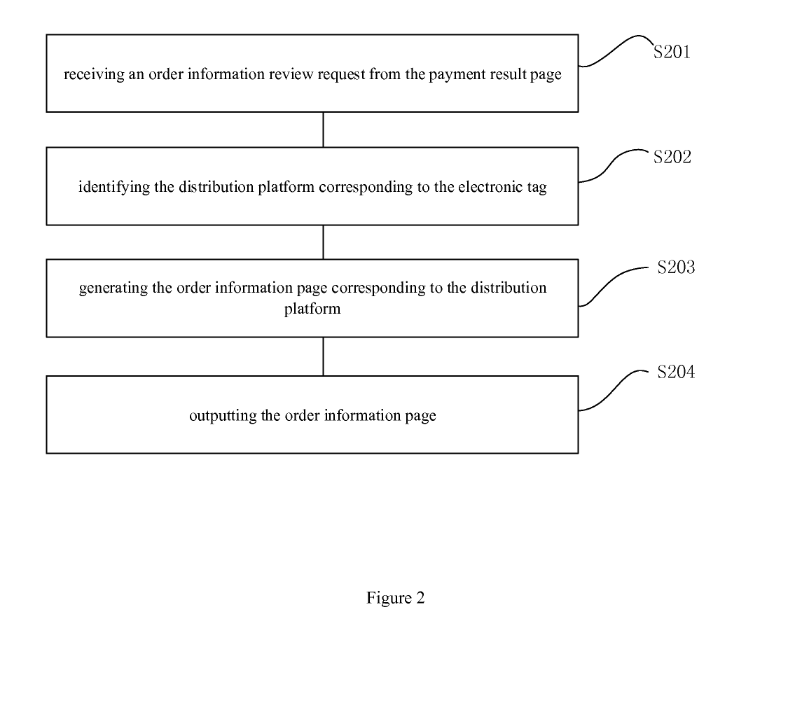

FIG. 2 is an exemplary flowchart for a method for processing electronic transaction information in accordance with a second embodiment of the present invention. As shown in FIG. 2, the method in this embodiment is similar to the method in the embodiment in FIG. 1, but further includes the following steps:

Step 201: receiving an order information review request from the payment result page.

As discussed above, after outputting the payment result page, the browser on the client parses, loads, and displays the payment result page. In addition to the payment result, the payment result page can also include a link to order information. The user can click this link to send an order information request to the server, and the server will correspondingly receive the order information request sent from the payment result page. Understandably, the order information request includes information such as the electronic tag and the order number.

Step 202: identifying the distribution platform corresponding to the electronic tag.

For example, the distribution platform that the electronic tag belongs to can be determined by searching the electronic tag database; and the order information page template corresponding to the distribution platform can also be obtained.

Step 203: generating the order information page corresponding to the distribution platform.

For example, order information can be obtained by searching order data using the order number, and the order information page can be obtained by filling the order information page template with the order information. Understandably, the present embodiment is not limited to using order information page template, and the order information page can be generated directly by codes.

Step 204: outputting the order information page.

Outputting the order information page may include, for example, returning the order information page to a client. The browser on the client can subsequently parse, load, and display the order information page. The display of the order information does not necessarily mean the end of the electronic transaction; in order to identify the distribution platform, the order information page can also include the electronic tag.

As compared with the method for processing electronic transaction information in the first embodiment, the present embodiment extends the use of the electronic tag to order information page, and expands the scope and applicability of the method for processing electronic transaction.

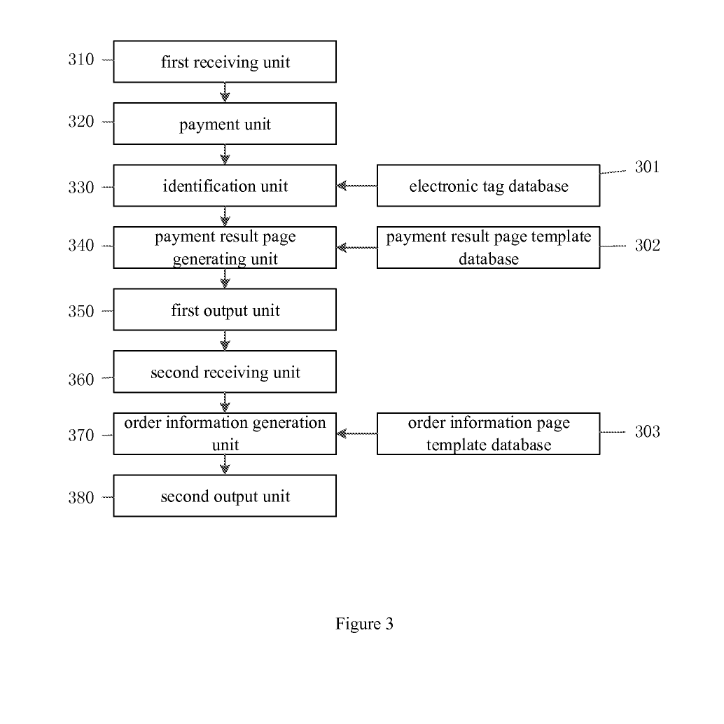

FIG. 3 is an exemplary schematic diagram for an apparatus for processing electronic transaction information in accordance with yet another embodiment of the present invention. As shown in FIG. 3, the apparatus includes a first receiving unit 310, a payment unit 320, an identification unit 330, a payment result page generating unit 340, and a first output unit 350.

The first receiving unit 310 is used for accepting a payment request submitted by a channel entrance page, the payment request comprising an electronic tag corresponding to the channel entrance page; the payment unit 320 is used for making a payment in accordance with the payment request and outputting a payment result; the identification unit 330 is used for identifying a distribution platform corresponding to the electronic tag; the payment result page generating unit 340 is used for generating a payment result page based on the identified distribution platform; for example, the payment result page generating unit 340 is used for obtaining a order information page template corresponding to the distribution platform and generating the order information page in accordance with the order information page template; and the first output unit 350 is used for outputting the payment result page.

The apparatus for processing electronic transaction information further includes an electronic tag database 301 and a payment result page template database 302, wherein each electronic tag in the electronic tag database 301 corresponds to a distribution platform, and each distribution platform has a channel entrance page; each payment result page template in the payment result page template database 302 corresponds to an electronic tag in the electronic tag database 301.

The apparatus for processing electronic transaction information further includes an order information page template database 303, wherein each order information page template in the order information page template database corresponds to an electronic tag in the electronic tag database 301.

The apparatus for processing electronic transaction information further includes a second receiving unit 360, an order information generation unit 370, and a second output unit 380.

The second receiving unit 360 is used for receiving an order information review request from the payment result page, the order information review request comprising the electronic tag; and the identification unit 330 is used for identifying the distribution platform corresponding to the electronic tag received by the second receiving unit.

The order information generation unit 370 is used for generating the order information page in accordance with the order information page template corresponding to the distribution platform; and the second output unit 380 is used for outputting the order information page;

FIGS. 1, 2 and the corresponding description above can be referenced for implementation details of the apparatus for processing electronic transaction in this embodiment.

In accordance with the apparatus for processing electronic transaction information of this embodiment, electronic tags are embedded in the processing steps of the electronic transactions, and two or more independent and closed transaction processing systems while sharing the same payment process can be established. Thus, the amount of work and cost for establishing electronic transaction distribution platforms can be reduced.

In accordance with embodiments of the present invention, a computer-readable medium having stored thereon computer-executable instructions is provided. The operations in the method for processing electronic transaction information described above can be implemented by computer hardware, or by a computer program controlling the relevant hardware. The computer program can also be stored and/or transported within any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any medium that can contain or store the program for use by or in connection with the instruction execution system, apparatus, or device. The computer readable medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The various embodiments of the present invention are merely preferred embodiments, and are not intended to limit the scope of the present invention, which includes any modification, equivalent, or improvement that does not depart from the spirit and principles of the present invention.

1. A method for processing electronic transaction information, the method comprising:
accepting a payment request submitted by a channel entrance page, the payment request comprising an electronic tag corresponding to the channel entrance page;
making a payment in accordance with the payment request and outputting a payment result;
identifying a distribution platform corresponding to the electronic tag;
generating a payment result page based on the identified distribution platform; and
outputting the payment result page.

2. The method of claim 1, further comprising, prior to accepting a payment request submitted by a channel entrance page:
constructing an electronic tag database of electronic tags, wherein each electronic tag in the electronic tag database corresponds to a distribution platform, and each distribution platform corresponds to a channel entrance page; and
constructing a payment result page template corresponding to each electronic tag in the electronic tag database.

3. The method of claim 2, further comprising, prior to accepting a payment request submitted by a channel entrance page:
constructing a order information page template corresponding to each electronic tag in the database.

4. The method of claim 1, wherein the payment result page comprises the electronic tag.

5. The method of claim 4, further comprising:
receiving an order information review request from the payment result page, the order information review request comprising the electronic tag;
identifying the distribution platform corresponding to the electronic tag;
generating the order information page in accordance with the order information page template corresponding to the distribution platform; and
outputting the order information page.

6. The method of claim 1, wherein the step of generating a payment result page based on the identified distribution platform comprises:
obtaining a payment result page template corresponding to the distribution platform;
and generating a payment result page in accordance with the payment result page template.

7. An apparatus for processing electronic transaction information, comprising:
a first receiving unit for accepting a payment request submitted by a channel entrance page, the payment request comprising an electronic tag corresponding to the channel entrance page;
a payment unit for making a payment in accordance with the payment request and outputting a payment result;
an identification unit for identifying a distribution platform corresponding to the electronic tag;
a payment result page generating unit for generating a payment result page based on the identified distribution platform; and
a first output unit for outputting the payment result page.

8. The apparatus of claim 7, further comprising:
an electronic tag database, wherein each electronic tag in the electronic tag database corresponds to a distribution platform, and each distribution platform corresponds to a channel entrance page; and
a payment result page template database, wherein each payment result page template in the payment result page template database corresponds to an electronic tag in the electronic tag database.

9. The apparatus of claim 8, further comprising:
an order information page template database, wherein each order information page template in the order information page template database corresponds to an electronic tag in the electronic tag database.

10. The apparatus of claim 7, wherein the payment result page comprises the electronic tag.

11. The apparatus of claim 10, further comprising:
a second receiving unit for receiving an order information review request from the payment result page, the order information review request comprising the electronic tag;
an order information generation unit for generating the order information page in accordance with the order information page template corresponding to the distribution platform; and
a second output unit for outputting the order information page;
wherein the identification unit is configured for identifying the distribution platform corresponding to the electronic tag received by the second receiving unit.

12. The apparatus of claim 7, wherein the payment result page generating unit is configured for:
obtaining a payment result page template corresponding to the distribution platform; and
generating a payment result page in accordance with the payment result page template.
